(19) United States
(12) Patent Application Publication
(10) Pub. No.: US 2020/0286373 A1
(43) Pub. Date: Sep. 10, 2020

(54) IN-VEHICLE ACTIVE TRAFFIC MANAGEMENT INFORMATION SYSTEM (IVATMIS)

(71) Applicant: Robert Gordon, Plainview, NY (US)

(72) Inventor: Robert Gordon, Plainview, NY (US)

(21) Appl. No.: 16/808,852

(22) Filed: Mar. 4, 2020

Related U.S. Application Data
(60) Provisional application No. 62/814,156, filed on Mar. 5, 2019.

(51) Int. Cl. G08G 1/09; H04W 4/44

(52) U.S. Cl. CPC G08G 1/091; H04W 4/44

(57) ABSTRACT

An In-Vehicle Active Traffic Management Information System (IVATMIS) that provides vehicles with messages derived from non-DMS and non-ADMS sources. IVATMIS receives, develops, and prioritizes the messages from these sources to provide suitable message streams to drivers of manually-driven vehicles and to self-driving vehicles that represents the indications on traffic Active Traffic Management device (ATM) deployments on freeways and bridges. The messages include and/or use information obtained from a traffic management center or from a source whose information originates from a traffic management center for ATM traffic management devices other than DMS and ADMS. The messages may include descriptions of traffic events and traffic conditions from Lane Control Signals, Variable Speed Limit Signs, dynamic lane markings, and dynamic toll rate information. This information may include required or suggested lane use, speed limits and traffic event descriptions that enable the driver or self-driving vehicle to infer descriptions of traffic events and conditions.

### CROSS REFERENCE OF RELATED APPLICATIONS

This patent application is a nonprovisional patent application of and claims priority from the provisional patent application Ser. No. 62/814,156 filed on Mar. 5, 2019, which is hereby incorporated by reference in its entirety. The Applicant hereby incorporates by reference the following patents and published patent application in their entirety, as well as all applications from which they claim priority or are incorporated therein by reference: U.S. Pat. Nos. 9,053,636, 9,286,800, 9,911,329, 9,799,218, and 9,965,953 and the application Ser. No. 15/412,494 (U.S. Publication No. 20170322046). The disclosures, drawings, abstracts, and claims of these patents and patent application, all of which are attributed to the Applicant, will be helpful in understanding the present invention.

### FIELD OF THE INVENTION

This invention was not made pursuant to any federally-sponsored research and/or development.

The present invention develops methods and systems for an In-Vehicle Active Traffic Management Information System (IVATMIS). IVATMIS includes the methods, functions and support equipment to provide suitable message streams to drivers of manually-driven vehicles and to self-driving vehicles that represents the indications on traffic Active Traffic Management device (ATM) deployments on freeways and on bridges (with the exception of dynamic message signs or DMS). The messages include and/or use information obtained from a traffic management center or from a source whose information originates from a traffic management center for ATM traffic management devices other than DMS.

The messages also include and/or use information obtained from a traffic management center or from a source whose information originates from a traffic management center that provides descriptions of traffic events and traffic conditions or that enables the driver or self-driving vehicle to infer descriptions of traffic events and traffic conditions, including Lane Control Signals (LCS), Variable Speed Limit Signs (VSLS), dynamic lane markings (DLM) and dynamic toll rate information (DTRI). This information may include any of the required or suggested lane use, speed limits and traffic event descriptions. IVATMIS may also provide messages of this type without the need for the physical presence of a DMS sign anywhere on the roadway.

### BACKGROUND

Motorist information devices on the roadway include dynamic message signs on limited access highways (DMS) and arterial dynamic message signs (ADMS) on surface street arterials. Connected vehicle technology makes it feasible to present this information to the motorist in the vehicle and to provide additional benefits to the motorist in so doing. Approaches for doing this are described in U.S. Pat. No. 9,911,329 (Gordon)¹. ¹ Gordon, R., U.S. Pat. No. 9,911,329, Enhanced Traffic Sign Information System; Gordon, R., U.S. Pat. No. 9,965,953, Enhanced Traffic Information Messaging System.

In recent years Lane Control Signals (LCS), Variable Speed Limit Signs (VSLS), dynamic lane markings (DLM) and dynamic toll rate information (DTRI) have been used (along with DMS) in active traffic management (ATM) deployments². ATM deployments feature combinations of these devices operating in real time to improve safety and congestion at roadway locations separated by relatively frequent intervals (e.g. 0.25 to 0.6 miles). ² Kuhn, B., Balke, K. and Wood, N., “Active Traffic Management (ATM) Implementation and Operations Guide”, Federal Highway Administration Report FHWA-HOP-17-056, December 2017.

This patent application provides a process for delivering information contained on LCS, VSLS, DTM and DTRI into the vehicle. The provision of information to the motorist in manually driven vehicles by audio means avoids the physical problems present with viewing roadway devices (driver visual distraction, occlusion from other vehicles, device malfunction, and/or weather-related visibility problems). The provision of this information to self-driving vehicles avoids errors associated with the vehicle's reading or interpreting roadway management device displays as well as occlusion from other vehicles, device malfunction and weather-related visibility problems, thereby improving safety.

### SUMMARY OF THE INVENTION

This patent application describes a process for providing information for other roadway motorist information devices other than DMS to drivers of manually driven vehicles on limited access highways and on bridges for which the driver controls lane choice and speed as well as to self-driving vehicles (both fully- and partially-automated vehicles). Such devices include lane control signals (LCS), variable speed limit signs (VSLS), dynamic lane markings (DLM) to manage lane use changes and lane reversals, and dynamic toll rate information (DTRI). Information on messages on DMS that may be at these locations are provided to the vehicle by other means such as those described in the Gordon patent.

In the aforementioned Gordon patents, the DMS information is provided to the driver when the vehicle is appropriately positioned and has the correct heading so as to properly use the information. This approach is employed in the current patent application for the other ATM devices.

### BRIEF DESCRIPTION OF THE DRAWINGS

The features, aspects and advantages of the novel In-Vehicle Active Traffic Management Information System will become further understood with reference to the following description and accompanying drawings where

FIG. 1 shows the relationship of the invention's processes to the inputs from other functions contributing to the process and the relationship of the outputs to the appropriate vehicle components;

FIG. 2 shows the relationship of the traffic management devices and their management sections to the roadway; and

FIG. 3 shows an example of the relationship of the messages on the ATM field devices to the messages provided by IVATMIS in manually driven vehicles and to self-driving vehicles.

### DESCRIPTION

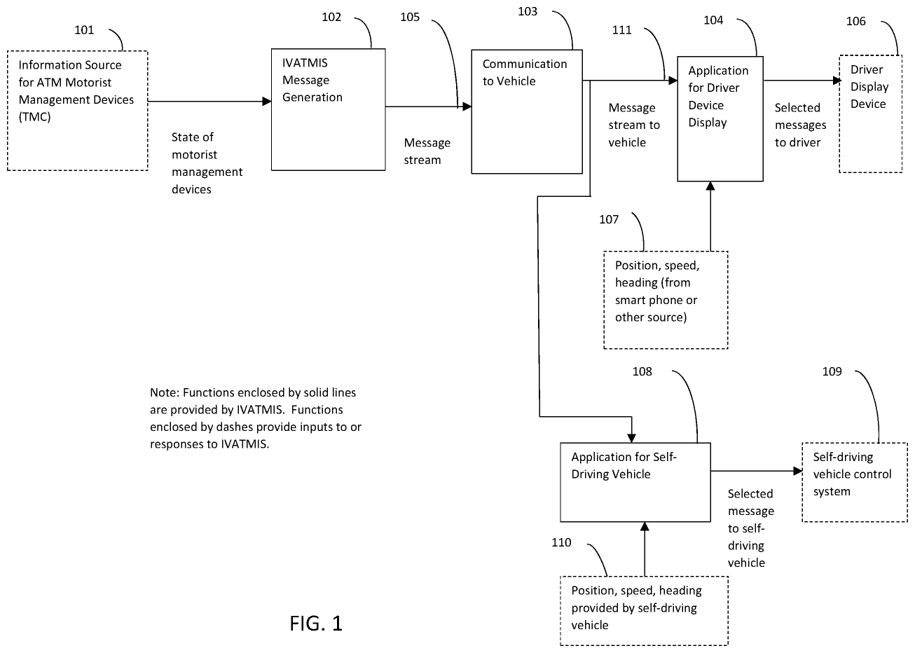

FIG. 1 shows the general relationship of the processes included in the IVATMIS process.

IVTAMIS Message Generation 102. This process may be performed by a stand-alone server or by a server shared with other functions. The server may be at a traffic management center (TMC) or elsewhere. It accesses information that originates at the TMC or other source 101 to manage the ATM ITS devices such as LOS, VSLS and DMS in the roadway. The state of the displays (e.g. lane change indication) at a device location for limited access highways and bridges is sent from the TMC or other source 101 to the IVATMIS Message Generation server.

The state of the ATM devices is provided by the TMC or other source 101 to the server hosting the IVATIMS process 102. A management section is associated with each device location. The IVATIMS Server 102 provides a message stream providing messages in an uncoded text format and coded messages corresponding to the device state for each of the management devices, except for DMS in each management section on the roadway.

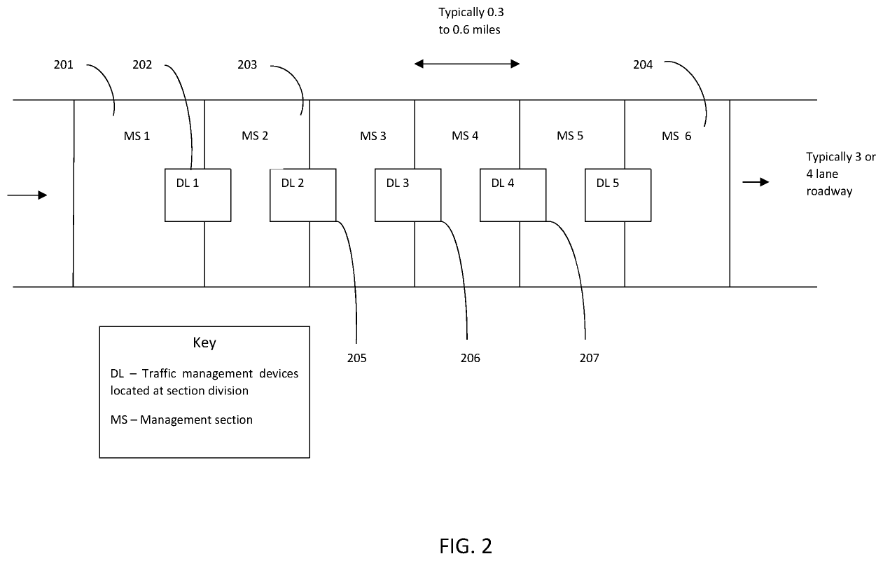

The following describes a process for developing the messages for each of the non-DMS devices. In-vehicle messaging for DMS (if required) is provided by other means, such as the Gordon patents. In ATM installations, a sequence of management devices at successive locations presents information to a motorist in a planned sequence. FIG. 2 shows an example of the relationship of the management sections for a small ATM installation. Devices such as LCS, VSLS and DMS are located at the management section downstream boundary for the first management section 201 and at the boundaries for the other sections as shown. LCS and VSLS display lane use and speed limits for the corresponding management section. Thus DL1 devices 202 will display instructions to be implemented by motorists in Management Section 1 201 prior to the vehicle's entering Management Section 2 203.

Data on the status of each ITS device at a device location is sent from the Information Source for Motorist Management Devices 101 to the server hosting the IVATMIS Message Generation 102 process. The IVATMIS Server 102 develops the following:
Text for a set of messages describing the motorist action to be taken to comply with the information on the management devices as well as other pertinent information. For example, the LCS and VSLS field equipment usually displays the result from the TMC operator's selecting these indications from a previously prepared set that identifies the indications from for all events and for all device locations. In one implementation the IVATMIS Message Generation process 102 replicates this information and uses it to describe the lane change messages and speed limits along with the event resulting in these actions. Optionally the message on a DMS at this location may also be provided to the manually driven vehicle by the use of another process such as that described by Gordon.
A coded representation of the actions (e.g. lane change and/or speed limit) that an automated vehicle must implement to comply with the states of the field devices.

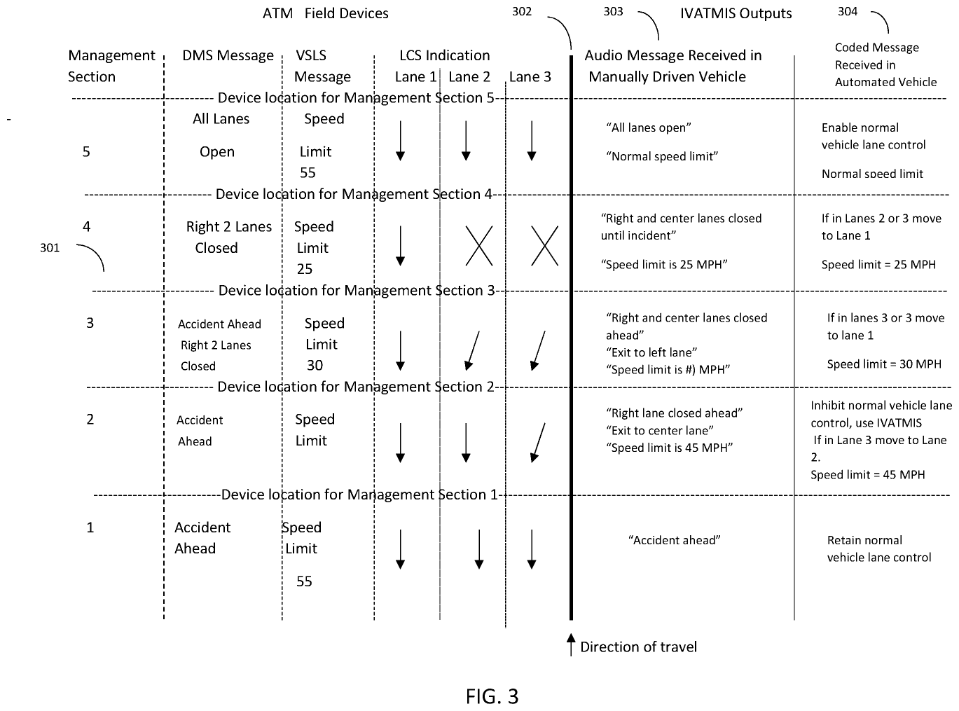

An example of the implementation of this process is shown in FIG. 3. This figure depicts the scenario for an accident that blocks the right and center lane in Management Section 4 301. The field device displays are shown to the left of the solid line 302, however no DMS information is used by IVATMIS in this example. In this example the IVATMIS Message Generation process 102 examines the LCS and VSLS displays as provided by the Information Source for Motorist Management Devices 101 and by comparing it to pre-stored data for all scenario alternatives selects the appropriate text format messages 303 and coded messages 304 from that data set.

An alternative to using text to transmit the messages is to use a formatted message to represent information on the device. Use of such a format facilitates message transmission to and interpretation by self-driving vehicles. A standard format such as that provided by the SAE Standard J2735³ data dictionary may be useful. DSRC stands for “Dedicated Short Range Communications”. For manually driven vehicles, either a text message or formatted message may be used. ³ Overview of DSRC Messages and Performance Requirements, Perry, F., May 3, 2017.

When the TMC operator responds to an event (e.g. incident, weather, construction, traffic conditions) and its location by controlling the ATM displays, this information is transmitted to the IVATIMS Message Generation Server 102. The IVATMIS Message Server 102 performs a number of operations. The following describes a possible process for message development and editing.

a. Development of Messages for Device Locations

For each event the prestored message components corresponding to that event, management section and the set of corresponding management device displays will be selected. A possible option omits the selection of messages that indicate normal conditions. An estimate of the time required to vocalize the message for each device location (e.g. DL 2 205 in FIG. 2) will be provided. This information becomes part of the message stream 105. The appropriate subset of prestored text or formatted messages that correspond to the event type and location are added to the message stream (the message stream is the set of messages corresponding to all device locations).

b. Establishment of Message Priorities

Message priorities are established for the purpose of restricting the length of the messages to be provided to the motorist in the Application for the Driver Display Device 104 to avoid motorist distraction in the event that a long message set is developed. Priority information is also used to limit the time available for a vocalized message so that it may fit within the time that the vehicle has remaining in the management section. Priority information is included in the message stream 105. The expected time duration of DMS messages, if employed, is also included (the audible DMS messages themselves are developed by another process (e.g. Gordon). A count of the characters in a message may be used to estimate the length and duration of the message component. A possible set of priorities in the order of importance for the components of a message for a device location is:
1 VSLS and LCS displays when an event provides abnormal conditions.
2 DMS messages when an event provides abnormal conditions.
3 Normal indications for devices associated with a management section (e.g. 204) following a management section containing an event.
4 Normal indication (optionally this condition may not be displayed).

Communication to Vehicle 103. IVATMIS requires one-way communication to the vehicle. The simplest and most ubiquitous implementation of this requirement for manually driven vehicles uses smartphones. The smartphone also provides vehicle position, speed and heading 107, all of which are required by the Application for the Driver Display Device Process 104. The Application for Self-Driving Vehicle 108 obtains this information from the vehicle 110. The smartphone, when used appropriately also provides one embodiment of the Driver Display Device 106.

Proprietary cellular based systems⁴ may provide the most convenient communications scheme for self-driving vehicles. These systems may also be used for manually driven vehicles. ⁴ The Ford Sync system is an example of a proprietary cellular based system.

Other alternative communication systems may be used. These include:
Satellite communications. Manually driven vehicles employing this technology must additionally provide position, speed and heading data.
Direct short-range communications (DSRC) using roadside units (RSUs) and on-board units (OBUs).⁵ The OBU provides position, speed and heading. ⁵ Irwin, S., Connected Car, Nokia, May 27, 2015.

Application for Driver Display Device 104. This process is employed for manually driven vehicles. It receives the message stream from the Communication to Vehicle Process 103 and provides suitable messages to the Driver Display Device 106. Specifics of this subprocess vary with the specific Driver Display Device 106 employed and with the format employed for the message stream to the vehicle 111. As an example, the following steps relate to the use of audio presentation of the message on a smartphone (or a suitable connection to it) as the Driver Display Device 106 and text as the message stream format.
a. Using position, speed and heading from a suitable source 107 such as a smartphone, determine whether the vehicle is in a management section 201. If this is the first management section entered in an ATM group, enable the rest of this procedure.
b. Select the messages for the current management section from the message stream to the vehicle 111. Each message represents a management device state at the traffic management device location for this section.
c. Place the messages in priority order.
d. From vehicle position and speed, estimate the time remaining for the vehicle to remain in this management section. Include the time required to provide DMS messages in this estimate.
e. Using the priority structure for audibly presented messages, eliminate portions of the message (including DMS messages) that may be provided by other means) that do not fit within the time limit set to avoid motorist distraction.
f. Provide messages to Driver Display Device 106. The text to speech capability in the smartphone provides the conversion for this example.

Application for Self-Driving Vehicle 108. This process is employed for self-driving vehicles. It receives the message stream from the Communication to Vehicle Process 103 and provides suitable messages to the self-driving vehicle control system 109.

Five levels of driving automation have been defined by the Society of Automotive Engineers.⁶ Level 3 (conditional automation) is the lowest level where the vehicle and not the driver monitors the driving environment. This process therefore applies to levels 3, 4 and 5 (the Application for Driver Display Device Process 104 applies to levels 1 and 2). ⁶ SAE Levels of Driving Automation—Center for Internet and Society, Stanford Law School.

This application may be implemented by a stand-alone data processor unit or may be incorporated into the vehicle's data processor. The description below assumes a separate processor.
a. Using position, speed and heading provided by the vehicle 110, determine whether the vehicle is in a management section 201. If this is the first management section entered in an ATM group, enable the rest of this procedure.
b. Select the messages for the current management section from the message stream to the vehicle 111. Each message component represents a management device state at the traffic management device location for this section.
c. Provide the selected messages to the self-driving vehicle control system 109 as illustrated in the last column of FIG. 3 304.

### ADDITIONAL CONCEPTS

Concept 1: A method for generating a traffic information message stream suitable for use by drivers of manually-driven vehicles and by self-driving vehicles that represents the indications on traffic Active Traffic Management device (ATM) deployments on freeways and on bridges (with the exception of dynamic message signs) comprising:
a. The use of information obtained from a traffic management center or from a source whose information originates from a traffic management center for ATM traffic management devices other than DMS.
b. The use of information obtained from a traffic management center or from a source whose information originates from a traffic management center that provides descriptions of traffic events and traffic conditions or that enables the driver or self-driving vehicle to infer descriptions of traffic events and traffic conditions.
c. Information that may include any of required or suggested lane use, speed limits and traffic event descriptions.

Concept 1-1: Use of a communication system to communicate the message stream to manually-driven vehicles and to self-driving vehicles.

Concept 2: A method for the use of management sections defined by the ATM field equipment placements to organize the messages in the message stream so that they may be provided to manually-driven vehicle drivers and to self-driving vehicles when the vehicles are in the appropriate location to take the required action.

Concept 3: A method for the provision of priorities for messages with the intent of limiting the length of the total message to be provided to manually-driven vehicle drivers in a management section to avoid driver distraction, and to fit within the time frame that the vehicle will remain in the current management zone.

Concept 3-1: The method of Concept 3 wherein an estimate of the time durations of the message components to be presented to the drivers of manually-driven vehicles is provided in the message stream.

Concept 4: A method for implementing an application for a smartphone or other device in a manually driven vehicle that selects messages from the traffic information message stream for the appropriate management section and vehicle direction and, when the vehicle is appropriately located and has the correct direction, presents the selected message to an appropriate display device.

Concept 4-1: The method of Concept 4 wherein the application limits the message according to a priority structure to a length that avoids motorist distraction, and fits within the time framed for the vehicle to remain in the current management zone.

Concept 5: A method for providing lane change information and speed limit information to self-driving vehicles to enable them to conform to the requirements of the displays on the ATM devices.

What is claimed is:

1. A method for providing traffic information messages, comprising:
a. receiving at an IVATMIS management center at a physical location or in the cloud a plurality of messages derived from a non-DMS source, said plurality of messages originating from a traffic management center (TMC), a regional traffic information management center or a traffic information service;
b. associating a management section including one or more parts of a roadway network containing the physical location of the non-DMS source;
c. communicating the plurality of messages to vehicles as text messages or coded messages; and
d. providing the text messages to drivers of the vehicles or providing the coded messages to automated driving systems of the vehicles, corresponding to a type of messages provided to the vehicles.

2. The method of claim 1, further comprising prioritizing messages from the plurality of messages to be provided to the vehicles as text messages or coded messages.

3. The method of claim 1, wherein the text messages or coded messages are adopted for presentation to the drivers by an audio stream or as text or a graphic on a display.

4. The method of claim 3, further comprising limiting the size of the text messages to be presented to the drivers to a total length that is safe and consistent with vehicle display constraints for motorist display purposes or to a physical size of the display.

5. The method of claim 1, wherein the physical location of the non-DMS source is in the management section where the vehicles are located.

6. The method of claim 1, wherein the physical location of the non-DMS source is outside of the management section where the vehicles are located.

7. The method of claim 1, further comprising identifying message components of each of the plurality of messages after receiving the plurality of messages and communicating the message components to the vehicles.

8. The method of claim 7, further comprising:
a. identifying a plurality of management sections to which the message components apply;
b. determining applicable messages for a particular management section originating from the non-DMS source;
c. transmitting the applicable messages to the vehicles; and
d. presenting the applicable messages to drivers of the vehicles by an audio stream or as text or a graphic on a display.

9. The method of claim 1, wherein the non-DMS source is selected from the group consisting of Lane Control Signals (LCS), Variable Speed Limit Signs (VSLS), dynamic lane markings, and dynamic toll rate information.

10. The method of claim 9, wherein information from the plurality of messages from the non-DMS source includes lane use, speed limit or a traffic event description that enables drivers of the vehicles or the automated vehicles to infer descriptions of traffic events and conditions.

11. The method of claim 2, further comprising assigning a priority level to each of the plurality of messages.

12. The method of claim 11, further comprising limiting the size of the applicable informational messages according to a priority structure, to a length of the applicable informational messages that avoids motorist distraction and operates with a time period the vehicles are anticipated to remain in the management section.

13. The method of claim 1, further comprising processing the coded messages to generate corresponding processed messages for presentation in a vehicle.

14. The method of claim 13, wherein the processing of the coded messages is performed in the vehicle.

15. A method for providing traffic information messages, comprising:
a. receiving at an IVATMIS management center at a physical location or in the cloud a plurality of messages derived from a non-DMS source, said plurality of messages originating from a traffic management center (TMC), a regional traffic information management center or a traffic information service;
b. associating a management section including one or more parts of a roadway network containing the physical location of the non-DMS source;
c. adding a subset of pre-stored text or formatted messages, corresponding to a traffic event type located in the management section, to the plurality of messages; and
d. communicating the plurality of messages and the subset of pre-stored text or formatted messages to vehicles as text messages or coded messages.

16. The method of claim 15, further comprising providing the text messages to drivers of the vehicles or providing the coded messages to automated driving systems of the vehicles.

17. An In-Vehicle Active Traffic Management Information System, comprising:
a. an interface for receiving at an IVATMIS management center at a physical location or in the cloud at least one message derived from a non-DMS source, said at least one message originating from a traffic management center (TMC), a regional traffic information management center or a traffic information service;
b. a processor coupled to the interface, wherein the processor receives the at least one message through the interface, associates a management domain including one or more parts of a roadway network containing the physical location of the non-DMS source; and
c. communications means coupled to the processor for communicating the at least one message to vehicles, wherein the processor transmits the at least one message through the communication means to one or more vehicles for presentation to drivers and to automated vehicles.

18. The In-Vehicle Active Traffic Management Information System of claim 17, wherein the processor processes the at least one message using one or more processing module operatively coupled to the processor for developing enhanced traffic messages.

19. The In-Vehicle Active Traffic Management Information System of claim 18, wherein the one or more processing module is selected from the group consisting of prioritizing the at least one message, analyzing the at least one message by message components, identifying roadway links for which the at least one message applies, and identifying the management domain in which the links are located.
